(19) United States
(12) Patent Application Publication
(10) Pub. No.: US 2024/0235752 A1
(43) Pub. Date: Jul. 11, 2024

(54) PROCESSING DEVICE, BASE STATION, COMMUNICATION SYSTEM, METHOD, AND STORAGE MEDIUM

(71) Applicant: KABUSHIKI KAISHA TOSHIBA, Tokyo (JP)

(72) Inventors: Yuki YONEZAWA, Ayase Kanagawa (JP); Koji AKITA, Yokohama Kanagawa (JP); Kentaro TANIGUCHI, Kawasaki Kanagawa (JP); Miyuki OGURA, Tachikawa Tokyo (JP); Tomoya TANDAI, Ota Tokyo (JP)

(73) Assignee: KABUSHIKI KAISHA TOSHIBA, Tokyo (JP)

(21) Appl. No.: 18/461,591

(22) Filed: Sep. 6, 2023

(30) Foreign Application Priority Data
Jan. 10, 2023 (JP) 2023-001758

(51) Int. Cl. H04L 5/00; H04W 72/56

(52) U.S. Cl. CPC H04L 5/0044; H04W 72/56

(57) ABSTRACT

According to one embodiment, a processing device includes a first layer, a second layer, a receiver unit configured to receive first data from the first layer, a processing unit configured to generate second data by changing the first data, and a transmitter unit configured to transmit the second data to the second layer. The first data includes a communication resource allocation request indicating a size of untransmitted. The processing unit is configured to generate the second data by changing the size of the untransmitted data.

### CROSS-REFERENCE TO RELATED APPLICATIONS

This application is based upon and claims the benefit of priority from Japanese Patent Application No. 2023-001758, filed Jan. 10, 2023, the entire contents of which are incorporated herein by reference.

### BACKGROUND

Embodiments described herein relate generally to a processing device, a base station, a communication system, a method, and a storage medium.

In radio communication between a radio communication terminal like a user equipment (hereinafter, simply referred to as an UE) and a base station, there is a problem that communication delay easily occurs in uplink communication from the UE to the base station. When data to be transmitted is generated, the UE transmits a request (also referred to as a scheduling request) for allocating communication resources (for example, a resource block defined with frequency and time) to the base station. The base station allocates a communication resource to the UE, and transmits information (also referred to as schedule information) indicating the allocated communication resource to the UE. When the UE receives the schedule information, the UE transmits the data to the base station by using the communication resource which is based on the schedule information. In this way, the UE cannot immediately transmit the data after generating the data to be transmitted.

The base station can allocate only communication resource for transmitting data with a relatively small size (for example, several 100 bytes) to the scheduling request. When the size of the transmitted data is large, the UE cannot transmit all data on the communication resource allocated with the scheduling request. The UE further transmits the allocation request. Specifically, when the UE transmits data using the communication resource allocated with the scheduling request, the UE transmits a buffer status report (BSR) describing a size of untransmitted data as well as the data to the base station. The base station allocates a communication resource with which data with a size corresponding to BSR can be transmitted. As described above, when the size of the transmitted data is large, delay due to the allocation with BSR also occurs in addition to delay due to the allocation with the scheduling request, and thus a communication delay time becomes long.

### BRIEF DESCRIPTION OF THE DRAWINGS

FIG. 1 is a diagram illustrating an example of a radio communication system according to first to fifth embodiments.

FIG. 2 is a diagram illustrating an example of functional layers of a base station according to the first to fifth embodiments.

FIG. 3 is a block diagram illustrating an example of a base station according to the first embodiment.

FIG. 4 is a diagram illustrating an example of control data to be transmitted from an external device to an external cooperation unit according to the first embodiment.

FIG. 5 is a diagram illustrating an example of an instruction related to a delay reducing process according to the first embodiment.

FIG. 6A is a diagram illustrating an example of a message before updating BSR (buffer status report).

FIG. 6B is a diagram illustrating an example of a message after updating BSR.

FIG. 7A is a diagram illustrating an example of inserting BSR when the message does not include BSR.

FIG. 7B is a diagram illustrating an example of inserting BSR after inserting BSR.

FIG. 8 is a diagram illustrating a comparative example of uplink communication of a base station that does not include the processing device according to the embodiments.

FIG. 9 is a diagram illustrating an example of uplink communication of a base station according to the first embodiment.

FIG. 10 is a block diagram illustrating an example of a base station according to the second embodiment.

FIG. 11 is a diagram illustrating an example of uplink communication of the base station according to the second embodiment.

FIG. 12 is a block diagram illustrating an example of a base station according to the third embodiment.

FIG. 13 is a diagram illustrating an example of uplink communication of the base station according to the third embodiment.

FIG. 14 is a block diagram illustrating an example of a base station according to a fourth embodiment.

FIG. 15 is a diagram illustrating an example of control data to be transmitted from an external device to an external cooperation unit according to the fourth embodiment.

FIG. 16 is a diagram illustrating an example of uplink communication of the base station according to the fourth embodiment.

FIG. 17 is a block diagram illustrating an example of a base station according to a fifth embodiment.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes, and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

In general, according to one embodiment, a processing device for a base station including a first layer and a second layer. The processing device includes a receiver unit configured to receive first data from the first layer, a processing unit configured to generate second data by changing the first data, and a transmitter unit configured to transmit the second data to the second layer. The first data includes a communication resource allocation request indicating a size of untransmitted data among data to be transmitted to the base station. The processing unit is configured to generate the second data by changing the size of the untransmitted data.

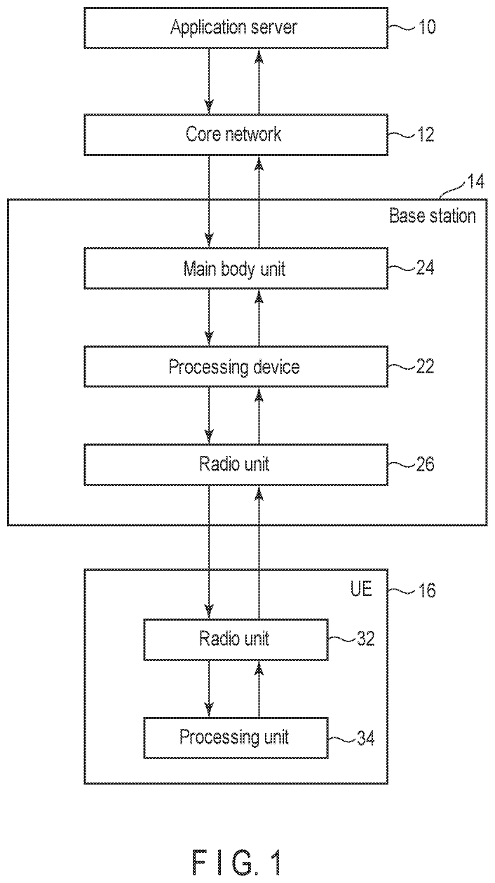

FIG. 1 is a diagram illustrating an example of a radio communication system according to first to fifth embodiments. An example of the radio communication system includes an application server 10, a core network 12, a base station 14, and at least one radio communication terminal (hereinafter referred to as an UE) 16. In the following description, the UE 16 is referred to as at least one radio communication terminal.

The UE 16 executes an application in cooperation with the application server 10. The application server 10 may be located on a cloud or on a physical server. The UE 16 transmits data to the application server 10 via the base station 14 and the core network 12. The UE 16 receives data from the application server 10 via the core network 12 and the base station 14. The UE 16 and the base station 14 are connected to each other by a wireless line. The base station 14 and the core network 12 form a defined network such as 4G or 5G. The base station 14 and the core network 12 may form a network that is defined after 5G.

A function of the base station 14 is logically divided into two functions. The base station 14 includes two functional units and a processing device 22 connected between the two functional units. Examples of the two functional units include a first communication unit (hereinafter referred to as a main body unit 24) that communicates with the core network 12, and a second communication unit (hereinafter referred to as a radio unit) 26 that communicates with the UE 16. The main body unit 24 corresponds to a MAC layer or a higher layer. The radio unit 26 corresponds to the PHY layer or a lower layer. An allocation unit (also referred to as a scheduler) that allocates a communication resource to the UE 16 in response to a request for allocating a communication resource from the UE 16 is located in the main body unit 24.

A function of the UE 16 is logically divided into two functions. The UE 16 includes two functional units. Examples of the two functional units are a radio unit 32 that communicates with the base station 14, and a processing unit 34 that communicates with the radio unit 32 and executes an application. The processing unit 34 receives data from the radio unit 32 or a sensor or an input unit (neither of which is illustrated), processes the data, and generates data to be transmitted to the base station 14 by executing the application. The size of the data generated by the processing unit 34 and a cycle at which the data is generated (that is, a cycle at which the UE 16 transmits the data) are determined by the application. For example, an application for controlling a robot receives outputs of various sensors and periodically generates a sensor signal with a predetermined size. The UE 16 periodically transmits the sensor signals to the application server 10 via the base station 14 and the core network 12. The application server 10 generates a robot control signal according to the sensor signal.

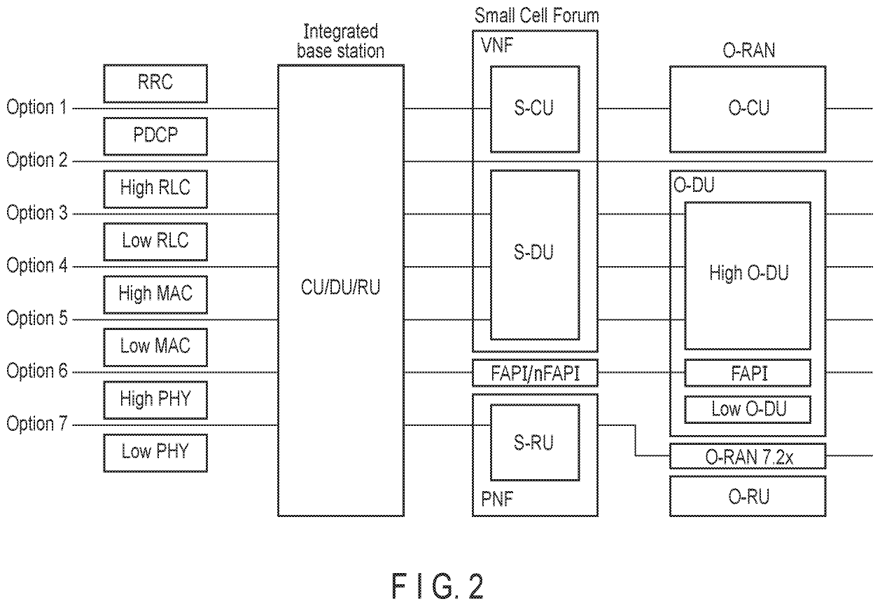

FIG. 2 is a diagram illustrating an example of functional layers of the base station 14 according to the first to fifth embodiments. According to the definition of 3GPP (registered trademark) (Third Generation Partnership Project), which is an example of a mobile communication system, the base station includes eight layers of Radio Resource Control (RRC), Packet Data Convergence Protocol (PDCP), High Radio Link Control (RLC), Low RLC, High Media Access Control (MAC), Low MAC, High Physical (PHY), and Low PHY. Interfaces between two adjacent layers from RRC to Low PHY are defined as Option 1 to Option 7, respectively.

High RLC and Low RLC may not be separate and may be implemented as one RLC layer. The High MAC and the Low MAC may not be separate and may be implemented as one MAC layer. The High PHY and the Low PHY may not be separate and may be implemented as one PHY layer.

The PHY layers (High PHY and Low PHY) correspond to the radio unit 26. RRC, PDCP, RLC (High RLC and Low RLC), and MAC (High MAC and Low MAC) layers correspond to the main body unit 24. The processing device 22 is located in Option 6.

The integrated base station includes a central unit (CU), a distributed unit (DU), and a radio unit (RU). The RU corresponds to the radio unit 26. The DU and the CU correspond to the main body unit 24.

As an association that defines a communication protocol between layers, there are Small Cell Forum and Open Radio Access Network (O-RAN). Small Cell Forum and O-RAN Alliance have slightly different layers corresponding to functions. In FIG. 2, RU, DU, and CU formulated by Small Cell Forum are respectively described as S-RU, S-DU, and S-CU. RU, DU, and CU formulated by O-RAN Alliance are respectively described as O-RU, O-DU, and O-CU.

In Small Cell Forum, a function of a base station is divided into a virtual network function (VNF) and a physical network function (PNF). VNF corresponds to the MAC layer and higher layers. PNF corresponds to the PHY layer and lower layers. An interface between VNF and PNF is defined as Option 6. The processing device 22 is located in Option 6. In Small Cell Forum, a communication protocol of Option 6 is defined as a Femto Application Platform Interface (FAPI)/network Functional Application Platform Interface (nFAPI) protocol. The processing device 22 conforms to the FAPI/nFAPI protocol.

A device or software referred to as a VNF corresponds to the main body unit 24. A device or software referred to as PNF corresponds to the radio unit 26. The two pieces of software may operate on two different devices or may operate on the same device. VNF includes S-CU and S-DU. S-CU corresponds to the RRC and PDPC layers. S-DU corresponds to the RLC and MAC layers. An interface between the S-CU and the S-DU is defined as Option 2. PNF includes S-RU.

The processing device 22 indirectly operates an upper or lower layer by inserting (or injecting) new data on a protocol while relaying data to be exchanged in conformity with the protocol. In an example of the FAPI/nFAPI protocol, the upper layer is a VNF and the lower layer is a PNF. The two layers are connected through socket communication. VNF designates an IP address and a port number of PNF. PNF designates an IP address and a port number of VNF.

When the processing device 22 transmits the data from PNF to VNF as it is, VNF can determine that VNF is connected to PNF. When the processing device 22 transmits the data from VNF to PNF as it is, PNF can determine that PNF is connected to VNF. Therefore, VNF and PNF do not recognize the presence of the processing device 22 but do recognize that VNF and PNF are connected to each other, and operate as a system without any problem. Transmission of the processing device 22 includes concepts of transmission and transfer of data, and reception of the processing device 22 includes reception of data.

The processing device 22 inserts new data into received data of a normal protocol according to a rule such as an order of packets defined in the protocol, for example. Thus, the upper layer and the lower layer do not determine that the new data is data inserted from a relayed layer (the processing device 22) and process the data as data defined in a normal protocol.

In O-RAN Alliance, a function of a base station is divided into O-CU, O-DU, and O-RU. O-CU corresponds to the RRC and PDCP layers. O-DU corresponds to High RLC, Low RLC, High MAC, Low MAC, and High PHY layers. O-RU corresponds to the Low PHY layer.

O-CU and O-DU correspond to the main body unit 24. An interface between O-CU and O-DU is defined as Option 2. An interface between O-DU and O-RU is defined as Option 7. The processing device 22 is located in Option 7. In O-RAN Alliance, the communication protocol of Option 7 is defined as an O-RAN 7.2x protocol. The processing device 22 conforms to the O-RAN 7.2x protocol.

O-DU is divided into High O-DU and Low O-DU. High O-DU corresponds to the High RLC, Low RLCP, High MAC, and Low MAC layers. Low O-DU corresponds to the High PHY layer.

An interface between High O-DU and Low O-DU is defined as Option 6. In O-RAN Alliance, a communication protocol of Option 6 is defined as an FAPI protocol.

O-RU corresponds to the radio unit 26.

### First Embodiment

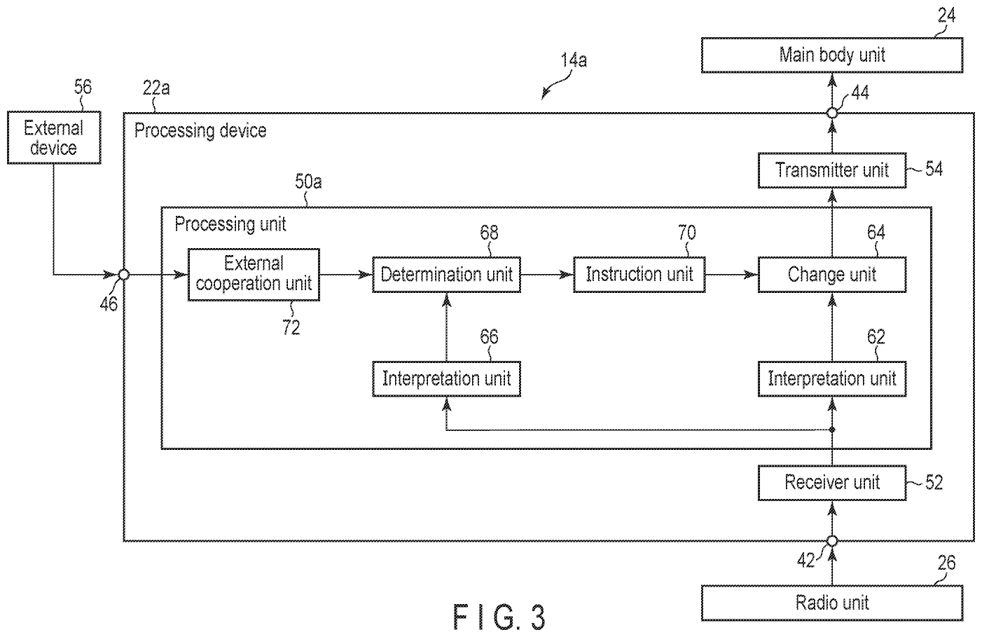

FIG. 3 is a block diagram illustrating an example of the base station 14a according to the first embodiment. An example of the base station 14a includes a processing device 22a. The processing device 22a includes a port 42, a port 44, a port 46, a receiver unit 52, a processing unit 50a, and a transmitter unit 54. The port 42 is connected to the radio unit 26. The port 44 is connected to the main body unit 24. The port 46 is connected to the external device 56. An example of the processing unit 50a includes interpretation units 62 and 66, a change unit 64, a determination unit 68, an instruction unit 70, and an external cooperation unit 72.

The radio unit 26 receives the transmitted data from the UE 16 and transmits the received data to the receiver unit 52 via the port 42. The receiver unit 52 transmits the received data to the interpretation units 62 and 66.

The interpretation unit 62 interprets the received data and determines whether the data includes BSR. The interpretation unit 62 transmits a determination result and the received data to the change unit 64. When the interpretation unit 62 determines that the data includes BSR, the interpretation unit 62 also transmits information indicating a position of BSR in the data to the change unit 64.

The interpretation unit 66 interprets the received data, detects identification information which is a radio network temporary identifier (RNTI) of the data transmission source UE 16, and transmits the RNTI and the received data to the determination unit 68. The RNTI is information used for a protocol in the base station 14a, and is identification information of the base station 14a.

The external cooperation unit 72 receives control data from the external device 56. The external device 56 is a multi-access edge computing (MEC), a cloud, or the like in which an application operates. The external cooperation unit 72 receives control data for controlling an operation of the processing device 22a from the external device 56.

The receiver unit 52 and the transmitter unit 54 may have a function of the external cooperation unit 72. In this case, the processing unit 50a does not include the external cooperation unit 72, and the processing device 22a does not include the port 46.

The processing unit 50a is one or more electronic circuits including a control device and an arithmetic device. The electronic circuit is realized with an analog or digital circuit or the like. For example, a general-purpose processor, a central processing unit (CPU), a microprocessor, a digital signal processor (DSP), an ASIC, an FPGA, and a combination thereof are applicable. The processing unit 50a may be implemented on these electronic circuits by software or a program.

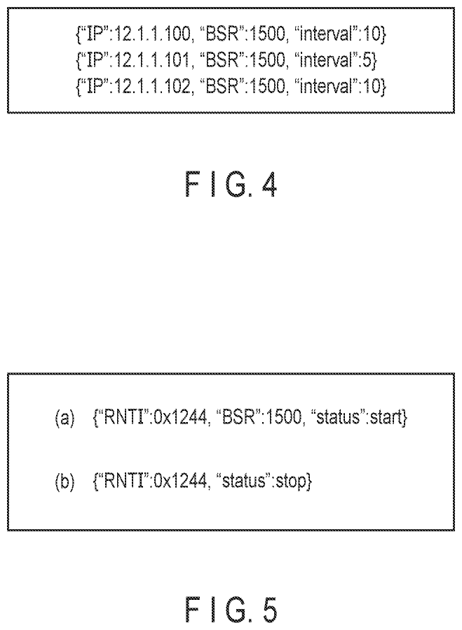

FIG. 4 is a diagram illustrating an example of control data to be transmitted from the external device 56 to the external cooperation unit 72. An example of the control data includes an IP address of the transmission source UE 16 of data related to BSR to be updated, an updated BSR (new BSR) (bytes), and a data transmission cycle (interval) (milliseconds). An operator of the external device 56 knows the data generation cycle and the data size for each UE 16. The operator of the external device 56 generates control data. The new BSR is set depending on the data size generated by the UE 16.

The external cooperation unit 72 stores link information between the IP address and the RNTI. When the external cooperation unit 72 receives the control data, the external cooperation unit 72 corrects the control data by converting an IP address in the control data into an RNTI. The external cooperation unit 72 transmits the corrected control data to the determination unit 68.

Based on the identification information RNTI of the UE 16 transmitted from the interpretation unit 66 and the RNTI in the corrected control data to be transmitted from the external cooperation unit 72, the determination unit 68 determines whether to start a delay reducing process of the uplink communication of the UE 16 identified by the RNTI. To execute the delay reducing process of the uplink communication is to update BSR included in the transmitted data of the UE 16 to BSR described in the control data.

Based on the reception timing of the transmitted data from the UE 16 and the interval included in the control data, the determination unit 68 estimates a subsequent transmission timing at which the UE 16 transmits the data subsequently (or timing at which the receiver unit 52 receives the data subsequently) and a size of the data to be transmitted. When the determination unit 68 determines to execute the delay reducing process, the determination unit 68 instructs the instruction unit 70 to start the delay reducing process before the subsequent transmission timing. A timing of the start instruction is determined such that the allocation of the communication resource to the UE 16 based on the new BSR will be completed by the subsequent transmission timing. As a result, when the UE 16 generates data, a communication resource for transmission have already been allocated. Since the UE 16 does not need to transmit an allocation request after generation of the data, the delay time of the uplink communication is shortened.

FIG. 5 is a diagram illustrating an example of an instruction related to the delay reducing process. The instruction is transmitted from the determination unit 68 to the instruction unit 70. An example of the instruction includes the RNTI of the transmission source UE 16 of data related to BSR to be updated, the updated BSR, and a status of the delay reducing process. An example of the status includes “start” and “stop”. When the receiver unit 52 receives data from the UE 16 which is an execution target of the delay reducing process, the determination unit 68 transmits a start instruction (a) illustrated in FIG. 5 to the instruction unit 70. When the receiver unit 52 ends the reception of the data from the UE 16 which is the execution target of the delay reducing process, the determination unit 68 transmits a stop instruction (b) illustrated in FIG. 5 to the instruction unit 70.

When the instruction unit 70 receives the start instruction (a) illustrated in FIG. 5, the instruction unit 70 causes the change unit 64 to start updating BSR. When the instruction unit 70 receives the stop instruction (b) illustrated in FIG. 5, the instruction unit 70 causes the change unit 64 to stop updating BSR.

The change unit 64 changes BSR in the data to be transmitted from the radio unit 26 to the main body unit 24 to the updated BSR described in the control data. When the data to be transmitted from the radio unit 26 to the main body unit 24 does not include BSR, the change unit 64 inserts BSR determined by the determination unit 68 into the data.

BSR is included in part of data (hereinafter referred to as a message) transmitted once from the UE 16. BSR represents a size of untransmitted data. The base station 14a allocates a communication resource according to BSR. The processing device 22a can change an amount of communication resource allocated to the UE 16 by the base station 14a by updating BSR. Specifically, the change unit 64 updates the message by changing the value of BSR included in the message transmitted from the UE 16 to the base station to a large value. Accordingly, the amount of allocated communication resource increases, and the size of data that can be transmitted at a time increases. Therefore, the number of communication resource allocation requests is reduced, and the delay time of the uplink communication is shortened. If the message transmitted from the UE 16 does not include BSR, the change unit 64 updates the message by inserting BSR into the message and setting the value of BSR to a large value.

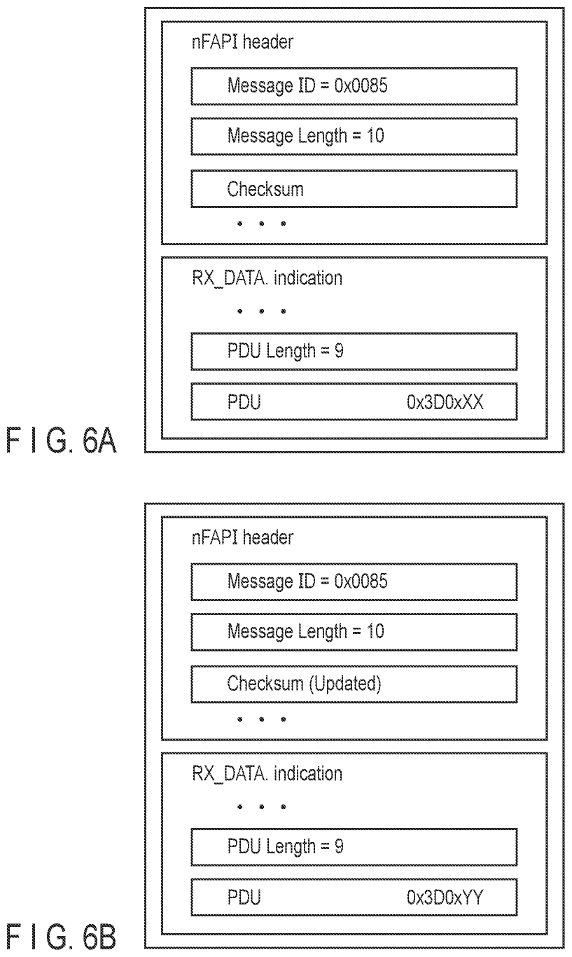

FIGS. 6A and 6B are diagrams illustrating an example of a process in which the change unit 64 changes BSR. FIG. 6A illustrates an example of a message before updating BSR. FIG. 6B illustrates an example of a message after updating BSR. The message includes an nFAPI header and RX_DATA.indication. The nFAPI header includes at least a message ID, a message length, and a checksum. RX_Data.indication includes at least a protocol data unit (PDU) length and a PDU. PDU includes a tag “0x3D” and an index (value) “0xXX” or “0xYY” of BSR. The change unit 64 changes the value of BSR from “0xXX” to “0xYY”. “0xYY” is BSR described in the control data and is larger than “0xXX”. When the index of BSR is updated, the checksum is also updated.

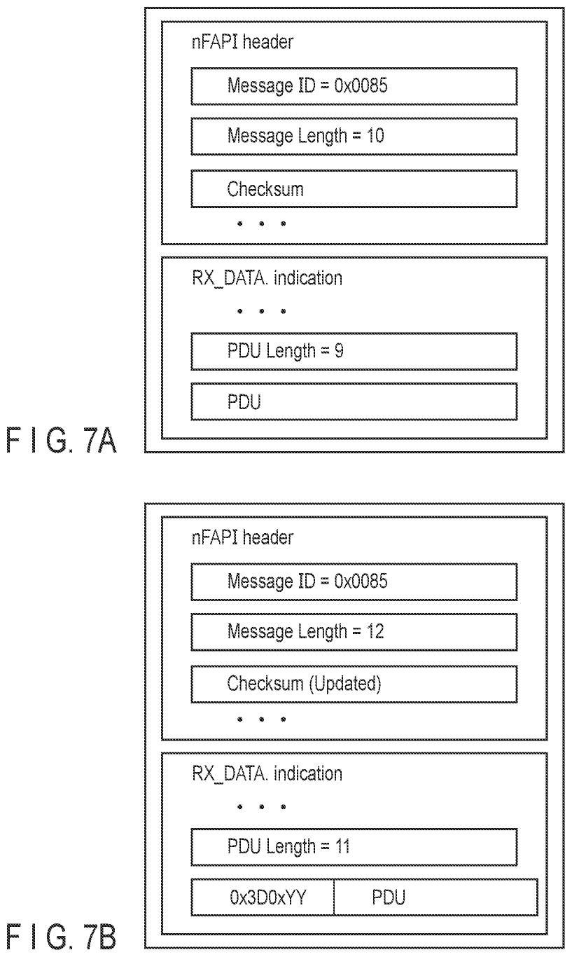

FIGS. 7A and 7B are diagrams illustrating an example of a process in which the change unit 64 inserts BSR into a message when the message does not include BSR. FIG. 7A illustrates an example of a message that does not include BSR. FIG. 7B illustrates an example of a message after inserting BSR. When the message does not include BSR, it is assumed that the message length is 10 bytes and PDU length is 9 bytes. It is assumed that both the tag and the index of BSR are 1 byte. Therefore, when BSR is inserted into a message, a message length becomes 12 bytes, and a PDU length becomes 11 bytes. There are the following three methods for inserting BSR tag into PDU. The first method is a method of inserting BSR tag into the head of PDU. In this method, BSR tag can be inserted into PDU without interpreting PDU. FIG. 7B illustrates an example in which BSR tag is inserted into the head of PDU. The second method is a method of inserting BSR tag into the middle of PDU. In this case, BSR tag needs to be placed before a padding tag. This is because the padding tag is used to set the data to a specific data size, and there is a high possibility of subsequent tags not being processed. The third method is a method of inserting BSR tag into the end of PDU. In this case, if there is a padding tag immediately before, there may be a possibility of not being processed depending on implementation of the base station. As indicated above, when the change unit 64 inserts BSR, the change unit 64 updates the message length, PDU length, and the checksum.

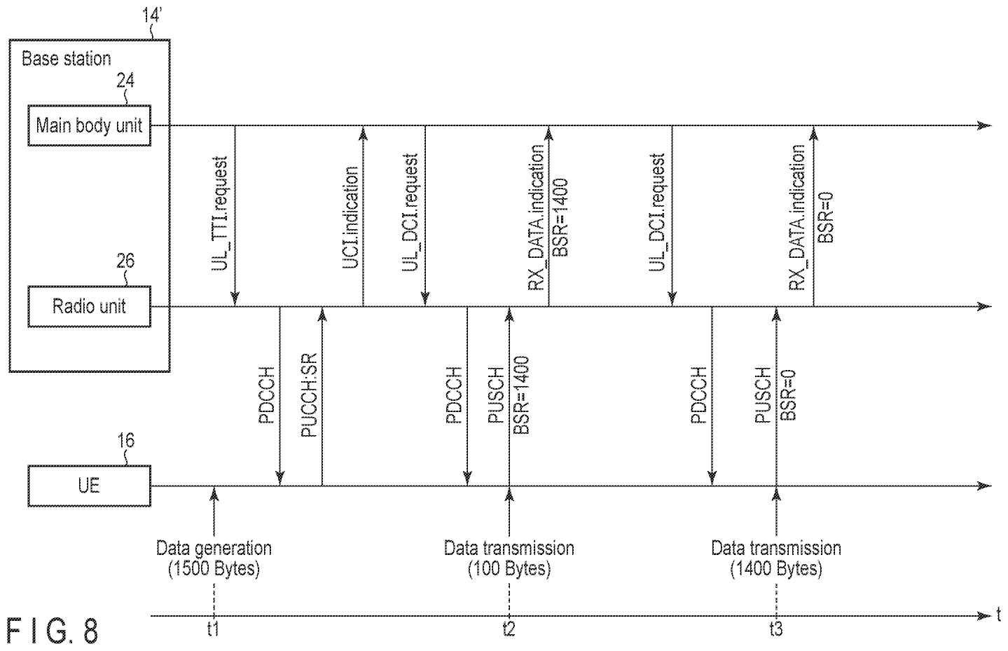

FIG. 8 is a diagram illustrating a comparative example of uplink communication of a base station 14′ that does not include the processing device 22, that is, does not update BSR in order to make comparison with the first embodiment.

In order to transmit PUCCH information according to radio resource control (RRC) from the radio unit 26 to the main body unit 24, the main body unit 24 periodically transmits UL_TTI.requests to the radio unit 26.

Although not illustrated, the radio unit 26 inserts UL_DCI.request into downlink control information (DCI) of data to be transmitted by a physical downlink control channel (PDCCH), and transmits DCI to the UE 16.

It is assumed that the UE 16 has already generated 1500-byte data at timing t1 before reception of UL_TTI.request. The UE 16 inserts a scheduling request (referred to as “SR” in the drawing) into uplink control information (UCI) transmitted to the base station 14′ by a physical uplink control channel (PUCCH) specified by DCI.

The radio unit 26 inserts the scheduling request transmitted by PUCCH into UCI.indication and transmits UCI.indication to the main body unit 24.

The allocation unit in the MAC layer (Low MAC or High MAC) of the main body unit 24 allocates a resource for uplink communication of data with a predetermined size, for example, 100 bytes in response to the scheduling request. A processing time from a time at which the allocation unit receives the scheduling request to a time at which the allocation unit allocates the communication resource is a delay time of the uplink communication. The main body unit 24 transmits UL_DCI.request including the schedule information indicating the communication resource allocated by the allocation unit to the radio unit 26.

The radio unit 26 inserts UL_DCI.request into DCI to be transmitted to the UE 16 by PDCCH.

At timing t2 after reception of PDCCH, the UE 16 transmits 100-byte data and BSR (=1400 bytes) by PUSCH to the base station 14′ using the communication resource indicated by the schedule information.

The radio unit 26 inserts the received data and BSR into RX_Data.indication transmitted to the main body unit 24. RX_Data.indication is a message that has a format as illustrated in FIGS. 6A, 6B, 7A, and 7B. PDU includes data and BSR.

The allocation unit in the main body unit 24 allocates a resource for the uplink communication of the untransmitted data to the UE 16 according to BSR. A processing time from a time at which the allocation unit receives BSR to a time at which the allocation unit allocates the communication resource is also a delay time of the uplink communication. The allocation unit does not necessarily allocate all the requested communication resource to the UE 16. The allocation unit may allocate only a communication resource of data smaller than the requested size. FIG. 8 illustrates an example in which the allocation unit allocates all the communication resource requested by BSR to the UE 16. The main body unit 24 transmits UL_DCI.request including schedule information indicating a communication resource of data with 1400 bytes allocated by the allocation unit to the radio unit 26.

The radio unit 26 inserts UL_DCI.request into DCI to be transmitted to the UE 16 by PDCCH.

At timing t3 after reception of UL_DCI.request, the UE 16 transmits 1400-byte data and BSR (=0) to the base station 14′ by PUSCH using the communication resource indicated by the schedule information.

When the allocation unit allocates only the communication resource of the data with a size smaller than the requested size, the data is transmitted at least once at timing t3 or later.

In this way, the UE 16 transmits a scheduling request to the base station 14′ and transmits data with a predetermined size by using a predetermined amount of allocated communication resource. When the size of the data to be transmitted is larger than the predetermined size, the UE transmits BSR together with the data when the UE transmits the data to the base station 14′. The base station 14′ allocates a communication resource to the UE 16 with which data according to BSR can be transmitted. The UE 16 transmits the untransmitted data by using the allocated communication resource. In the comparative example illustrated in FIG. 8, delay occurs at the time of allocation by the scheduling request and delay also occurs at the time of allocation by BSR. Thus, the delay time of the uplink communication is long.

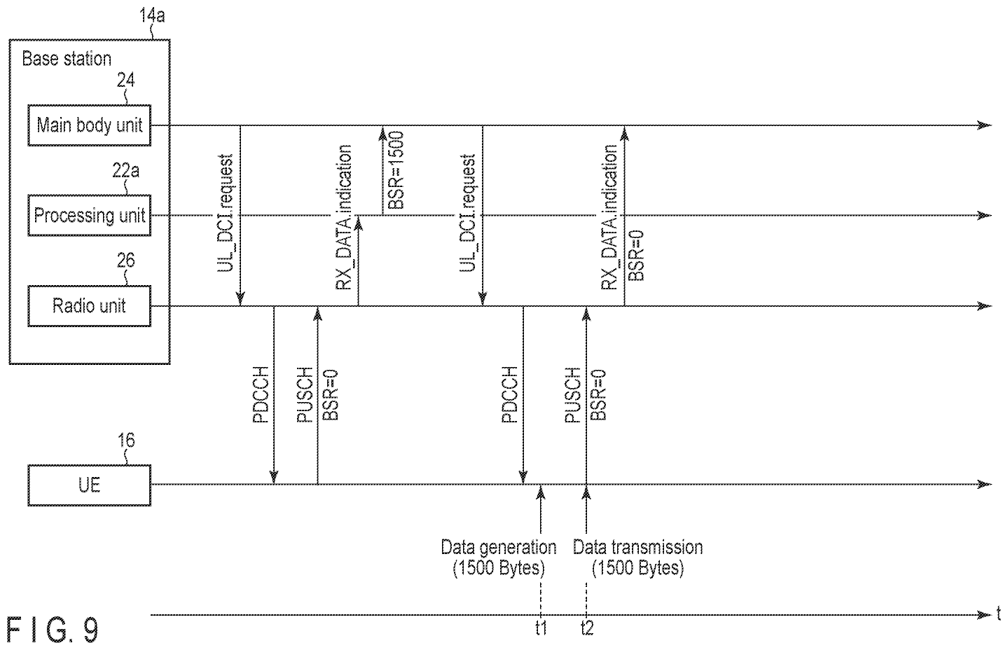

FIG. 9 is a diagram illustrating an example of uplink communication of the base station 14a according to the first embodiment. The base station 14a includes the main body unit 24, the processing unit 22a, and the radio unit 26.

The main body unit 24 transmits UL_DCI.request including schedule information indicating the communication resource allocated by the allocation unit. Though not illustrated in FIG. 8, the main body unit 24 transmits UL_TTI.request to the radio unit 26 in order to receive RX_Data.indication.

The radio unit 26 inserts UL_DCI.request into DCI to be transmitted to the UE 16 by PDCCH.

At this time, it is assumed that there is no data to be transmitted to the base station 14a in the UE 16. The UE 16 transmits only BSR (=0) to the base station 14a by PUSCH specified by DCI.

The radio unit 26 inserts the received BSR into RX_Data.indication to be transmitted to the main body unit 24. RX_Data.indication is a message that has a format as illustrated in FIGS. 6A, 6B, 7A, and 7B. Here, PDU does not include valid data. Data included in PDU is invalid data.

It is assumed that at timing at which the radio unit 26 transmits RX_Data.indication to the main body unit 24, the processing device 22a has already predicted that the UE 16 will generate 1500-byte data at the future timing t1 based on reception timing of the past transmitted data from the UE 16 and the interval included in the control data.

When the processing device 22a receives RX_Data.indication (here, PDU does not include valid data) as illustrated in FIG. 6A and a data transmission source UE 16 is a target UE related to BSR to be updated, the change unit 64 changes RX_Data.indication by updating a value (=0) of BSR in RX_Data.indication to BSR (=1500) described in the control data. The processing device 22a transmits changed RX_Data.indication as illustrated in FIG. 6B to the main body unit 24.

When RX_Data.indication does not include BSR as illustrated in FIG. 7A, the change unit 64 changes RX_Data.indication by inserting BSR with a value of 1500 (BSR described in the control data) into PDU of RX_Data.indication, and transmits changed RX_Data.indication to the main body unit 24 as illustrated in FIG. 7B.

The allocation unit in the main body unit 24 allocates a resource for uplink communication of 1500-byte data predicted to be generated at timing t1 to the UE 16 according to BSR included in RX_Data.indication. The main body unit 24 transmits UL_DCI.request including schedule information indicating a communication resource of 1500-byte data allocated by the allocation unit to the radio unit 26.

The radio unit 26 inserts UL_DCI.request into DCI of the data to be transmitted by PDCCH, and transmits DCI to the UE 16.

The UE 16 receiving UL_DCI.request transmits 1500-byte data and BSR (=0) to the base station 14a by PUSCH by using the communication resource indicated by the schedule information at timing t2.

When it is predicted that data will be generated in the future based on the control data to be transmitted from the external device 56, the processing device 22a according to the first embodiment updates BSR included in the message transmitted from the UE 16 according to BSR described in the control data. BSR described in the control data depends on the size of data predicted to be generated. Accordingly, the main body unit 24 can allocate the communication resource with which the untransmitted data can be transmitted at a time to the UE 16 before timing at which the data will be generated. The delay time of the uplink communication is shortened. Further, since untransmitted data other than the data to be transmitted by using the communication resource allocated in response to the scheduling request is transmitted at a time, jitter does not occur between a plurality of transmissions.

### Second Embodiment

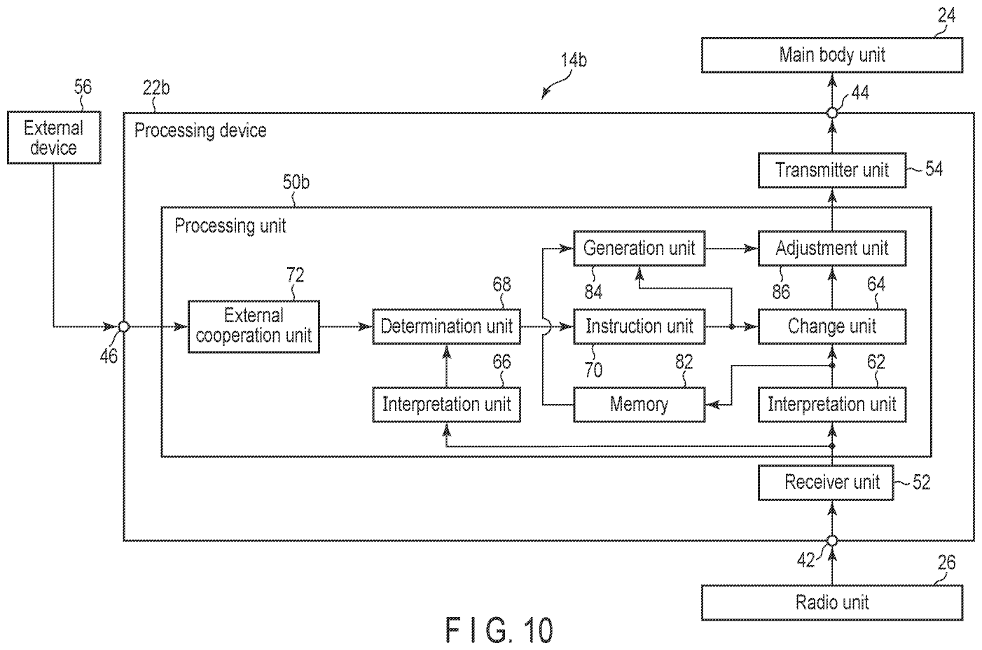

FIG. 10 is a block diagram illustrating an example of a base station 14b according to a second embodiment. Examples of the base station 14b include a processing device 22b. The processing device 22b includes a processing unit 50b instead of the processing unit 50a according to the first embodiment. The processing unit 50b includes a memory 82, a generation unit 84, and an adjustment unit 86 in addition to the units of the processing unit 50a. The processing device 22a according to the first embodiment updates BSR to reduce the delay of the uplink communication. As a premise of update of the BSR, it is necessary for the UE 16 to transmit data including BSR. The processing device 22b according to the second embodiment generates a message for causing the UE 16 to transmit data including BSR.

The generation unit 84 generates a message for causing the UE 16 to perform uplink communication. In the case of the FAPI/nFAPI protocol, the message is UCI.indication including a scheduling request. When UCI.indication is received, the main body unit 24 allocates a communication resource to the UE 16 in response to the scheduling request in UCI.indication and transmits allocation information to the UE 16. The UE 16 transmits the data and BSR to the base station 14b by PUSCH in accordance with the allocation information.

The processing device 22b generates RX_Data.indication in order to change BSR of RX_Data.indication transmitted from the radio unit 26 to the main body unit 24. To generate RX_Data.indication, UCI.indication is necessary. Therefore, the instruction unit 70 causes the generation unit 84 to generate UCI.indication.

The memory 82 stores parameters used for the generation unit 84 to generate the message. Examples of the parameters include a received signal strength indicator (RSSI) and a channel quality indicator (CQI). The generation unit 84 includes these parameters in UCI.indication. Examples of the memory 82 include a random access memory (RAM), a volatile memory (VM), and a non-volatile memory (NVM).

The generation unit 84 transmits generated UCI.indication to the adjustment unit 86.

The adjustment unit 86 inserts UCI.indication into the message transmitted from the radio unit 26 to the main body unit 24. Consecutive sequence numbers are attached to messages transmitted from the radio unit 26 to the main body unit 24. When the message generated by the generation unit 84 is inserted into the message transmitted from the radio unit 26 to the main body unit 24, the adjustment unit 86 changes the sequence number of the message so that the sequence number of the message transmitted from the adjustment unit 86 to the main body unit 24 become a consecutive number. Accordingly, the main body unit 24 can process the message added by the processing device 22b as a message transmitted from the UE 16.

A message included in UCI.indication is not limited to the schedule request. UCI.indication may include various types of data as follows.
(U1) SR
(U2) HARQ ACK/NACK
(U3) HARQ ACK/NACK, SR
(U4) CSI
(U5) CSI, SR
(U6) HARQ ACK/NACK, CSI
(U7) HARQ ACK/NACK, CSI, SR
CSI indicates channel state information.

UCI.indication may or may not include a schedule request. When the schedule request is added to UCI.indication that does not include the schedule request, UCI.indication that does not include the schedule request is changed to UCI.indication that includes the schedule request. Therefore, when the message transmitted from the radio unit 26 to the main body unit 24 does not include UCI.indication, the processing device 22b may cause the generation unit 84 to include the scheduling request in UCI.indication that does not include the scheduling request, instead of causing the generation unit 84 to generate UCI.indication and to insert the UCI.indication to the message to be transmitted to the main body unit 24. When a new UCI.indication is inserted to the message, a communication band between the radio unit 26 and the main body unit 24 is consumed, or the number of messages processed by the main body unit 24 increases. Thus, an increase in processing delay of the entire radio communication is assumed. When the conventional UCI.indication is used, this problem does not occur, and thus the processing delay does not occur.

When UCI.indication transmitted from the radio unit 26 does not include the schedule request as illustrated in the above (U2), (U4), and (U6), the schedule request as illustrated in the above (U3), (U5), and (U7) are inserted to UCI.indication. By insert the schedule request, UCI.indication not including the schedule request can be changed to UCI.indication including the schedule request.

When the message transmitted from the radio unit 26 to the main body unit 24 is UCI.indication not including the scheduling request, the processing device 22b supplies an instruction to add the schedule request to UCI.indication to the generation unit 84. The generation unit 84 inserts the schedule request to UCI.indication in the adjustment unit 86.

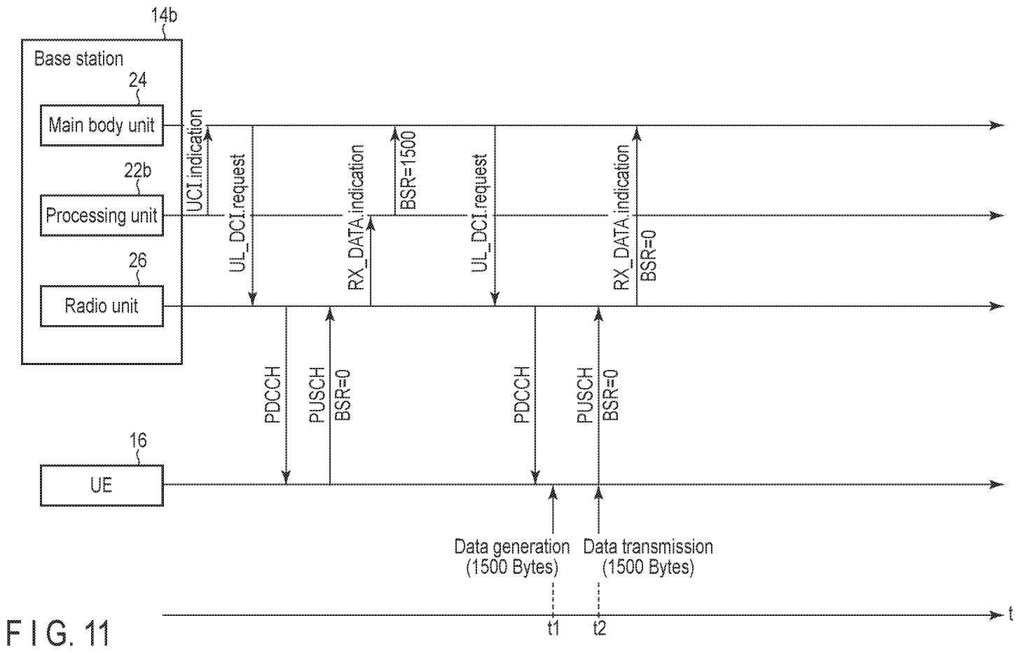

FIG. 11 is a diagram illustrating an example of uplink communication of the base station 14b according to the second embodiment.

When the message transmitted from the radio unit 26 to the main body unit 24 does not include UCI.indication, the processing device 22b generates UCI.indication including the scheduling request and transmits generated UCI.indication to the main body unit 24. When the message transmitted from the radio unit 26 to the main body unit 24 is UCI.indication not including the scheduling request, the processing device 22b adds the scheduling request to UCI.indication, and transmits updated UCI.indication including the scheduling request to the main body unit 24.

The allocation unit in the MAC layer (Low MAC or High MAC) of the main body unit 24 allocates a resource of uplink communication of data with a predetermined size, for example, 100 bytes in response to the scheduling request in UCI.indication. The main body unit 24 transmits UL_DCI.request including the schedule information indicating the communication resource allocated by the allocation unit to the radio unit 26.

The radio unit 26 inserts UL_DCI.request into DCI to be transmitted to the UE 16 by PDCCH.

Hereinafter, similarly to the first embodiment illustrated in FIG. 9, it is assumed that there is no data to be transmitted to the base station 14b at this time in the UE 16. The UE 16 transmits only BSR (=0) to the base station 14b by PUSCH specified by DCI.

The radio unit 26 inserts received BSR into RX_Data.indication to be transmitted to the main body unit 24. RX_Data.indication is a message that has a format as illustrated in FIGS. 6A, 6B, 7A, and 7B. At this time, RX_Data.indication includes BSR (=0) and does not include any other valid data. Here, depending on an UE, PDU may not include BSR (=0).

It is assumed that at timing at which the radio unit 26 transmits RX_Data.indication to the main body unit 24, the processing device 22 has already predicted that the UE 16 will generate 1500-byte data at a future timing t1.

When the processing device 22a receives RX_Data.indication (here, PDU does not include valid data) as illustrated in FIG. 6A and the UE 16 transmits data related to BSR to be updated, the change unit 64 changes RX_Data.indication by updating the value (=0) of BSR in the message to 1500 (BSR described in the control data). The processing device 22a transmits changed RX_Data.indication as illustrated in FIG. 6B to the main body unit 24.

When RX_Data.indication does not include BSR as illustrated in FIG. 7A, the change unit 64 changes RX_Data.indication by inserting BSR with a value of 1500 into PDU of RX_Data.indication, and transmits changed RX_Data.indication to the main body unit 24 as illustrated in FIG. 7B.

The allocation unit in the main body unit 24 allocates, to the UE 16, a resource for uplink communication of 1500-byte data predicted to be generated at timing t1 according to BSR included in received RX_Data.indication. The main body unit 24 transmits UL_DCI.request including schedule information indicating a communication resource of 1500-byte data allocated by the allocation unit to the radio unit 26.

The radio unit 26 inserts UL_DCI.request into DCI of the data to be transmitted by PDCCH, and transmits DCI to the UE 16.

The UE 16 receiving UL_DCI.request transmits 1500-byte data and BSR (=0) to the base station 14b by PUSCH by using the communication resource indicated by the schedule information at timing t2.

The processing device 22a according to the first embodiment waits for the UE 16 to transmit data to the base station 14a in some cases. However, the processing device 22b according to the second embodiment can cause the UE 16 to transmit the data and BSR by transmitting UCI.indication including the scheduling request to the main body unit 24. Therefore, the processing device 22b according to the second embodiment has a shorter delay time than the processing device 22a according to the first embodiment. An influence of jitter is also small.

### Third Embodiment

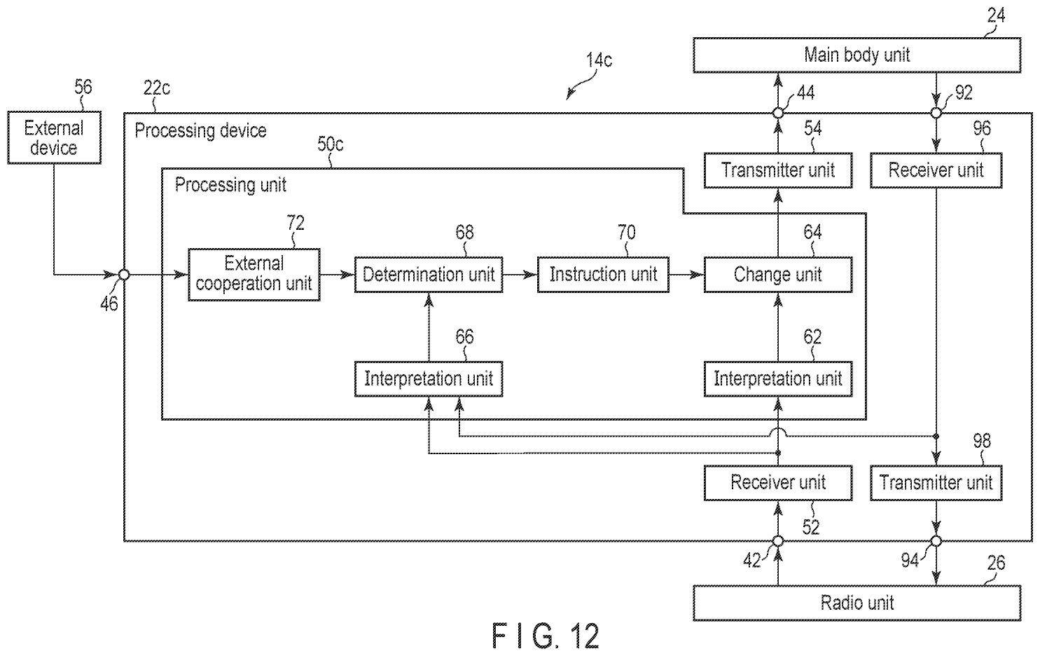

FIG. 12 is a block diagram illustrating an example of a base station 14c according to a third embodiment. An example of the base station 14c includes a processing device 22c. The processing device 22c further includes a port 92, a port 94, a receiver unit 96, and a transmitter unit 98, in addition to the units of the processing device 22a according to the first embodiment. The port 92 is connected to the main body unit 24. The port 94 is connected to the radio unit 26. The receiver unit 96 is connected to the port 92. The transmitter unit 98 is connected to the port 94. An output signal of the receiver unit 96 is transmitted to the transmitter unit 98 and the interpretation unit 66.

BSR is a request, and it is not clear whether the allocation unit allocates a communication resource according to BSR. The allocation unit may allocate only resource fewer than the communication resource with which the data predicted to be generated can be transmitted. Or, the allocation unit may conversely allocate more resources than the communication resource with which the data predicted to be generated can be transmitted. The processing device 22c according to the third embodiment detects the communication resource allocated by the allocation unit, and changes BSR that is an allocation request according to a detection result.

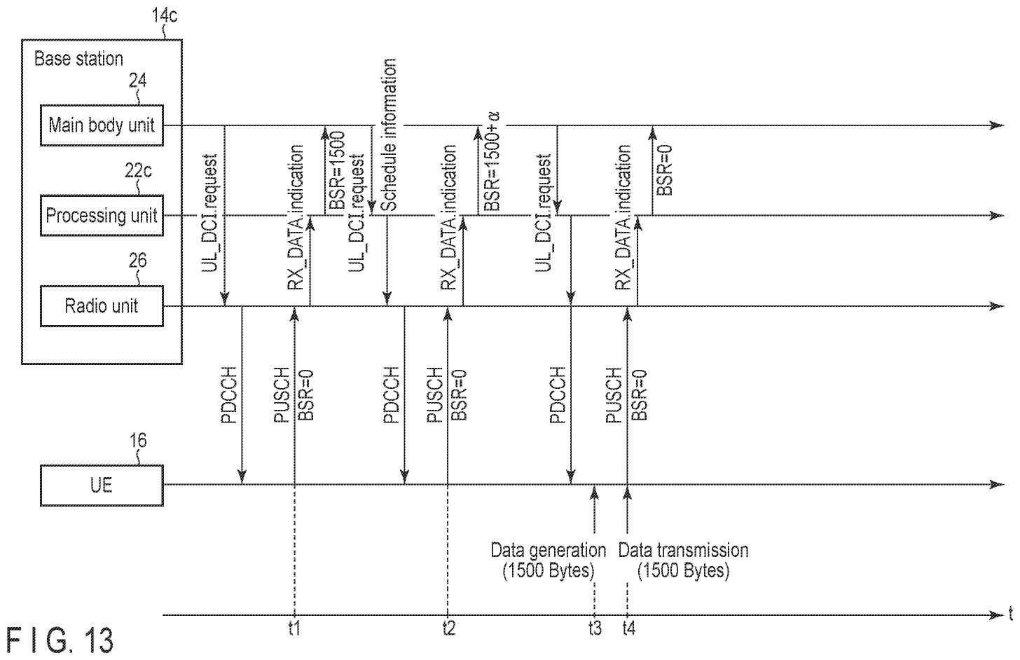

FIG. 13 is a diagram illustrating an example of uplink communication of the base station 14c according to the third embodiment.

The main body unit 24 transmits UL_DCI.request including the schedule information indicating the communication resource allocated by the allocation unit to the radio unit 26.

The radio unit 26 inserts UL_DCI.request into DCI to be transmitted to the UE 16 by PDCCH.

At this time, it is assumed that there is no data to be transmitted to the base station 14c in the UE 16. At timing t1, the UE 16 transmits only BSR (=0) to the base station 14c by PUSCH specified by DCI.

The radio unit 26 inserts the received BSR into RX_Data.indication to be to be transmitted to the main body unit 26. RX_Data.indication is a message that has a format as illustrated in FIGS. 6A, 6B, 7A, and 7B. Here, PDU does not include valid data. Data included in PDU is invalid data.

It is assumed that at timing at which the radio unit 26 transmits RX_Data.indication to the main body unit 24, the processing device 22 has already predicted that the UE 16 will generate 1500-byte data at a future timing t3.

When the processing device 22a receives RX_Data.indication (here, PDU does not include valid data) as illustrated in FIG. 6A and the UE 16 transmits data to be updated, the change unit 64 changes RX_Data.indication by updating the value (=0) of BSR in the message to 1500. The processing device 22a transmits changed RX_Data.indication as illustrated in FIG. 6B to the main body unit 24.

When RX_Data.indication does not include BSR as illustrated in FIG. 7A, the change unit 64 changes RX_Data.indication by inserting BSR with a value of 1500 into PDU of RX_Data.indication, and transmits changed RX_Data.indication to the main body unit 24 as illustrated in FIG. 7B.

The allocation unit in the main body unit 24 allocates the communication resource according to BSR included in received RX_Data.indication to the UE 16. The main body unit 24 transmits UL_DCI.request including the schedule information indicating the communication resource allocated by the allocation unit to the radio unit 26.

The processing device 22c receives UL_DCI.request transmitted to the radio unit 26, detects a communication resource actually allocated by the allocation unit from the schedule information, and obtains a data size that can be transmitted with the allocated communication resource. The processing device 22c sets a difference between BSR and the data size that can be transmitted with the allocated communication resource as a correction value α.

α=(data size that can be transmitted with the allocated communication resource)−BSR

The radio unit 26 inserts UL_DCI.request into DCI to be transmitted to the UE 16 by PDCCH.

At timing t2, the UE 16 transmits only BSR (=0) to the base station 14c by PUSCH specified by DCI.

The radio unit 26 inserts the received BSR into RX_Data.indication to be transmitted to the main body unit 24.

When the processing device 22a receives RX_Data.indication (here, PDU does not include valid data) as illustrated in FIG. 6A, the change unit 64 changes RX_Data.indication by updating the value (=0) of BSR in the message to 1500+α. The processing device 22a transmits changed RX_Data.indication as illustrated in FIG. 6B to the main body unit 24.

The allocation unit in the main body unit 24 allocates the communication resource according to BSR included in received RX_Data.indication to the UE 16. When the processing device 22c updates BSR by adding the correction value α to the value of BSR transmitted from the UE 16, the data size that can be transmitted with the communication resource allocated by the allocation unit matches BSR.

The main body unit 24 transmits UL_DCI.request including the schedule information indicating the communication resource allocated by the allocation unit to the radio unit 26.

The radio unit 26 inserts UL_DCI.request into DCI to be transmitted to the UE 16 by PDCCH.

The UE 16 receiving UL_DCI.request transmits 1500-byte data and BSR (=0) to the base station 14c by PUSCH using the communication resource indicated by the schedule information at timing t4.

The processing device 22c according to the third embodiment compares BSR that is the allocation request with the data size that can be transmitted with the communication resource allocated by the allocation unit. When BSR is different from the data size, a correction value by which a difference between BSR and the data size is 0 is added to BSR. Accordingly, the data size that can be transmitted with the communication resource allocated by the allocation unit matches BSR, and the communication resource with which the data desired to be transmitted can be transmit is allocated to the UE 16. Thus, the delay time of the uplink communication is shortened.

### Fourth Embodiment

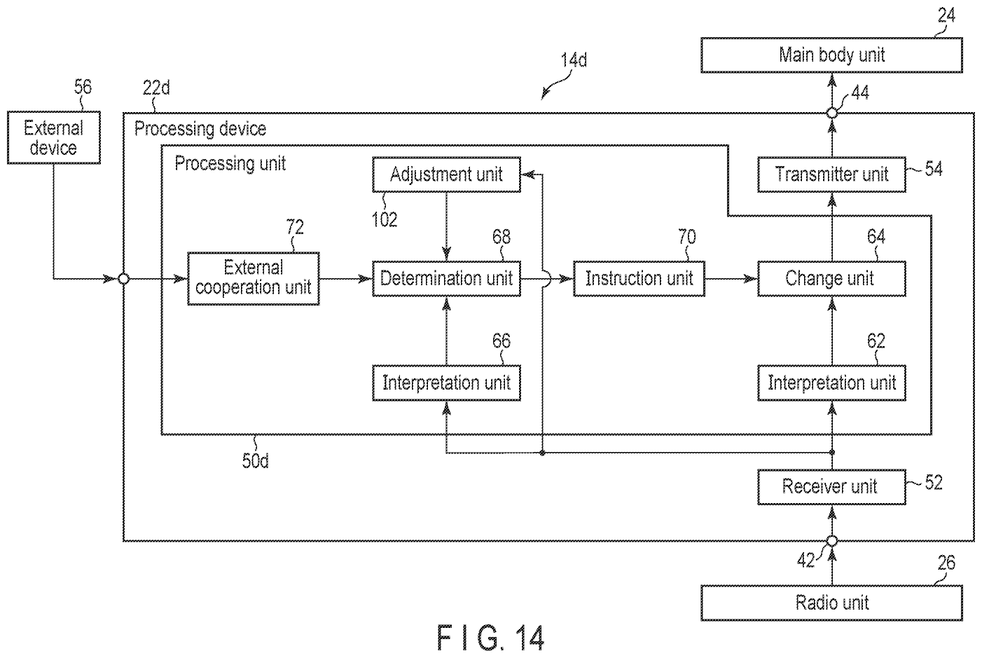

FIG. 14 is a block diagram illustrating an example of a base station 14d according to a fourth embodiment. An example of the base station 14d includes a processing device 22d. The processing device 22d includes a processing unit 50d instead of the processing unit 50a according to the first embodiment. The processing unit 50d further includes an adjustment unit 102 in addition to the units of the processing unit 50a. An output signal of the receiver unit 52 is transmitted to the adjustment unit 102. An output signal of the adjustment unit 102 is transmitted to the determination unit 68.

When each of a plurality of UEs 16 requests a large communication resource, communication resources cannot be allocated to all of the UEs 16, as requested, in some cases. Therefore, there is a possibility of a communication resource not being allocatable to an UE with which communication is to be preferentially executed as compared with other UEs, or a time is required for the allocation. This situation differs depending on an execution situation of an application of the UE 16. The adjustment unit 102 adjusts BSRs from a plurality of UEs 16 in order to cause an UE desired to be prioritized to preferentially start communication.

The external cooperation unit 72 receives control data for controlling an operation of the processing device 22d from the external device 56.

An operator of the external device 56 knows a priority for each UE 16. The priority is a priority related to transmission of data. The operator of the external device 56 desires to shorten a delay time of the uplink communication of the UE 16 with a high priority as compared with a delay time of the uplink communication of the UE 16 with a low priority. The operator of the external device 56 generates control data.

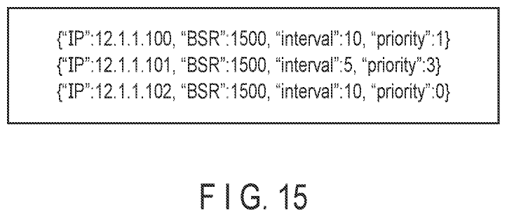

FIG. 15 is a diagram illustrating an example of control data to be transmitted from the external device 56 to the external cooperation unit 72. An example of the control data includes an IP address of the transmission source UE 16 of data related to BSR to be updated, BSR (new BSR) (bytes) after updating, a data transmission cycle (interval) (milliseconds), and a priority. An UE of which a priority number is larger has a higher priority. An UE of which a priority number is smaller has a lower priority. An UE of which an IP address is 12.1.1.101 has a priority of 3, and therefore has the highest priority. An UE of which an IP address is 12.1.1.100 has a priority of 1, and therefore has the second highest priority. An UE of which an IP address is 12.1.1.102 has a priority of 0, and thus is the UE with the lowest priority.

The adjustment unit 102 updates BSRs from a plurality of UEs 16 according to the priorities included in the control data.

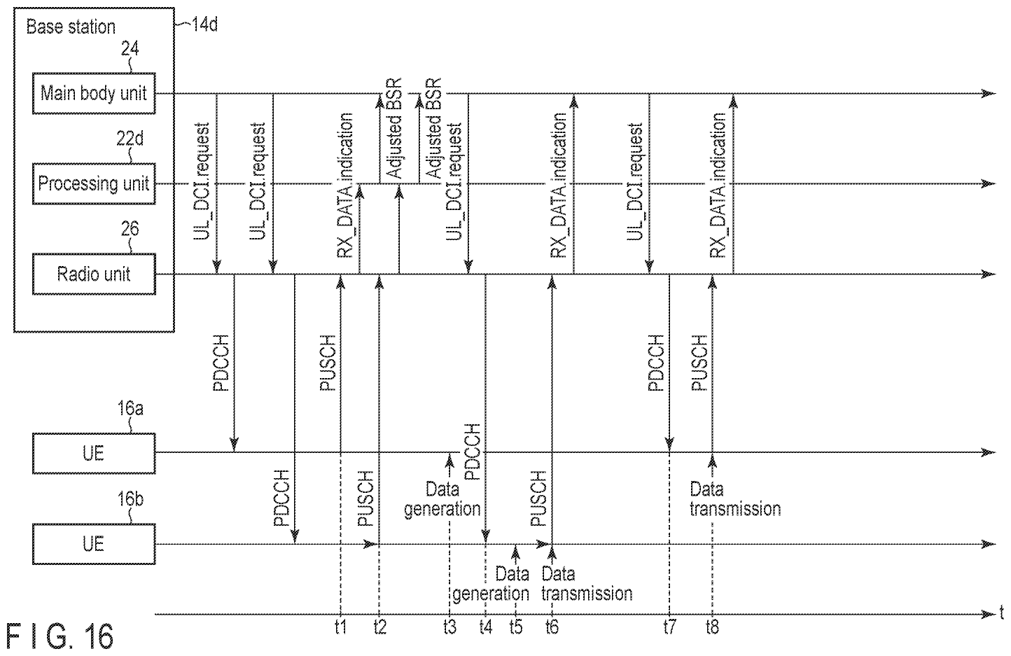

FIG. 16 is a diagram illustrating an example of uplink communication of the base station 14d according to the fourth embodiment.

The main body unit 24 transmits UL_DCI.request including schedule information indicating the communication resource allocated to an UE 16a by the allocation unit to the radio unit 26. The main body unit 24 also transmits UL_DCI.request including a schedule information indicating a communication resource allocated to an UE 16b by the allocation unit to the radio unit 26. It is assumed that the priority of the UE 16b is higher than the priority of the UE 16a (priority number is larger). An order of the transmission of UL_DCI.request of the UE 16a to the radio unit 26 and the transmission of UL_DCI.request of the UE 16b to the radio unit 26 may be reversed in FIG. 16. The priority of the UE 16b is higher than the priority of the UE 16a (priority is higher).

The radio unit 26 inserts UL_DCI.request for the UE 16a into DCI to be transmitted to the UE 16a by PDCCH. The radio unit 26 inserts UL_DCI.request for the UE 16b into DCI to be transmitted to the UE 16b by PDCCH.

At this time, it is assumed that there is no data to be transmitted to the base station 14d in the UEs 16a and 16b. At timing t1, the UE 16a transmits only BSR (=0) to the base station 14d by PUSCH specified by DCI. At timing t2, the UE 16b transmits only BSR (=0) to the base station 14d by PUSCH specified by DCI. The transmission timing of BSR of the UE 16a and the transmission timing of BSR of the UE 16b may be reverse to each other in FIG. 16.

The radio unit 26 inserts BSR of the UE 16a into RX_Data.indication to be transmitted to the main body unit 24. The radio unit 26 inserts BSR of the UE 16b into RX_Data.indication to be transmitted to the main body unit 24. RX_Data.indication is a message that has a format as illustrated in FIGS. 6A, 6B, 7A, and 7B. Here, PDU does not include valid data. Data included in PDU is invalid data. RX_Data.indication is a message that has a format as illustrated in FIGS. 6A, 6B, 7A, and 7B. Here, PDU does not include valid data. Data included in PDU is invalid data.

At timing (after t1) at which the radio unit 26 transmits RX_Data.indication related to the UE 16a to the main body unit 24, the processing device 22d has already predicted that the UE 16a generates data with a predetermined size at a future timing t3 based on the control data. At timing (after t2) at which the radio unit 26 transmits RX_Data.indication related to the UE 16b to the main body unit 24, the processing device 22d has already predicted that the UE 16b generates data with a predetermined size at a future timing t5 based on the control data. A sequence of timings t3 and t5 may be reversed.

The adjustment unit 102 in the processing device 22d supplies an instruction to the determination unit 68. The instruction is to adjust BSR described in the control data supplied from the external cooperation unit 72 according to the priority. The determination unit 68 adjusts BSR described in the control data supplied from the external cooperation unit 72 according to the priority. The determination unit 68 transmits the control data including the adjusted BSR to the instruction unit 70. The adjustment unit 102 sets the adjusted BSR of the UE with a high priority to a large value and sets the adjusted BSR of the UE with a low priority to a small value.

When the processing device 22d receives RX_Data.indication (here, PDU does not include valid data) as illustrated in FIG. 6A for each of the UEs 16a and 16b, the change unit 64 updates a value (=0) of BSR in RX_Data.indication to the adjusted BSR described in the control data of each of the UEs 16a and 16b, and changes RX_Data.indication.

The processing device 22a transmits changed RX_Data.indication in the format as illustrated in FIG. 6B to the main body unit 24.

When changed RX_Data.indication does not include BSR as illustrated in FIG. 7A, the change unit 64 changes RX_Data.indication by inserting BSR with a value of an adjusted BSR into PDU of RX_Data.indication, and transmits changed RX_Data.indication to the main body unit 24 as illustrated in FIG. 7B.

The allocation unit in the main body unit 24 allocates a resource for the uplink communication of the data predicted to be generated at timing t3 to the UE 16a according to the adjusted BSR included in RX_Data.indication related to the UE 16a. The allocation unit allocates the resource for the uplink communication of the data predicted to be generated at timing t5 to the UE 16b according to the adjusted BSR included in RX_Data.indication related to the UE 16b. The allocation unit preferentially allocates a communication resource to an UE with a large value of the adjusted BSR. Therefore, timing at which the allocation unit allocates the communication resource may be different from an order in which the data is generated.

For example, since the UE 16b has a higher priority than the UE 16a, the allocation unit may first allocate a communication resource to the UE 16b and then allocate a communication resource to the UE 16a.

The main body unit 24 transmits UL_DCI.request including the schedule information indicating the communication resource allocated to the UE 16b by the allocation unit to the radio unit 26.

At timing t4, the radio unit 26 inserts UL_DCI.request into DCI of the data to be transmitted by PDCCH, and transmits DCI to the UE 16b.

The UE 16b receiving UL_DCI.request transmits the data and BSR (=0) to the base station 14d by PUSCH using the communication resource indicated by the schedule information at timing t6.

Subsequently, the main body unit 24 transmits UL_DCI.request including the schedule information indicating the communication resource allocated to the UE 16a by the allocation unit to the radio unit 26.

At timing t7, the radio unit 26 inserts UL_DCI.request into DCI of the data to be transmitted by PDCCH, and transmits DCI to the UE 16a.

The UE 16a receiving UL_DCI.request transmits the data and BSR (=0) to the base station 14d by PUSCH using the communication resource indicated by the schedule information at timing t8.

The processing device 22d according to the fourth embodiment adjusts BSR described in the control data for each UE 16 received from the external device 56 according to the priority of the UE. Therefore, the communication resource is preferentially allocated to the UE 16 with a high priority. It is possible to prevent a situation in which the UE with the high priority cannot transmit data.

### Fifth Embodiment

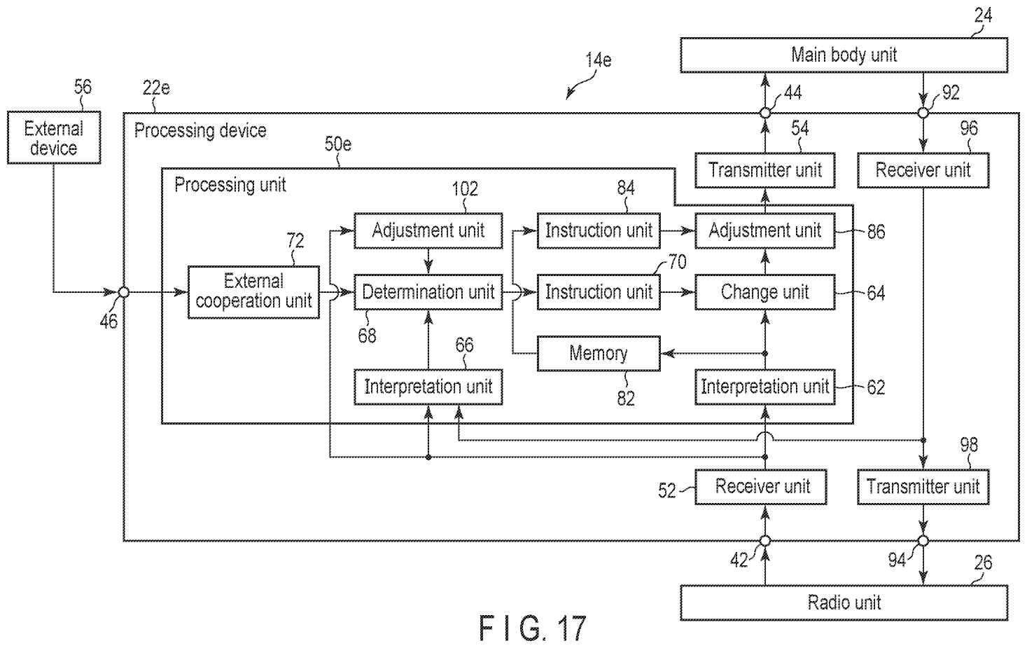

At least two of the first to fourth embodiments can be implemented in combination. FIG. 17 is a block diagram illustrating an example of a base station according to a fifth embodiment in which the first to fourth embodiments are all combined, for example. Although not illustrated, it is also possible to combine two or three of the first to fourth embodiments.

### Sixth Embodiment

In the above-described first to fifth embodiments, the processing device 22 includes a plurality of functional units (the interpretation units 62 and 66, the change unit 64, the determination unit 68, the instruction unit 70, the external cooperation unit 72, and the like) that implement a plurality of functions. However, the processing device 22 may include at least one functional unit that implements a plurality of functions.

At least one functional unit may include one or more CPUs, FPGAs, or the like or may include dedicated hardware. A program executed by one or more CPUs, FPGAs, or the like is stored in a memory included in the processing device 22. The example described in the memory 82 can be applied to this memory.

According to the embodiments, following processing device, base station, communication system, communication method, and storage medium are provided.

(1) A processing device for a base station including a first layer and a second layer, the processing device comprising:
a receiver unit configured to receive first data from the first layer;
a processing unit configured to generate second data by changing the first data; and
a transmitter unit configured to transmit the second data to the second layer, wherein
the first data includes a communication resource allocation request indicating a size of untransmitted data among data to be transmitted to the base station; and
the processing unit is configured to generate the second data by changing the size of the untransmitted data.

(2) The processing device according to (1), wherein the processing unit is configured to
estimate transmission timing of the data to be transmitted to the base station; and
generate the second data before the transmission timing.

(3) The processing device according to (2), wherein the processing unit is configured to
estimate a transmission size of the data to be transmitted to the base station; and
   change the size of the untransmitted data depending on the transmission size.

(4) The processing device according to (3), wherein
the processing device is configured to receive identification information of a data generation source, a data generation cycle, and a data size from an external device; and
generate the second data based on the identification information, the data generation cycle, and the data size.

(5) The processing device according to (3), wherein the processing unit is configured to
cause the receiver unit to receive first allocation information indicating a communication resource determined, in response to the second data, by the second layer; and
update the size of the untransmitted data depending on the transmission size and the first allocation information.

(6) The processing device according to (1), wherein the processing unit is configured to
generate third data including a second allocation request from the first data;
cause the transmitter unit to transmit the third data to the second layer;
cause the receiver unit to receive second allocation information indicating a communication resource determined, in response to the second allocation request, by the second layer; and
cause the transmitter unit to transmit the second allocation information to the first layer.

(7) The processing device according to (1), wherein
the first layer is connected to radio communication terminals;
the first data is data to be transmitted to the first layer by each of the radio communication terminals;
a priority is determined for each of the radio communication terminals; and
the processing unit is configured to generate a plurality of the second data by changing the plurality of a plurality of the first data to be transmitted from the radio communication terminals based on the priorities of the radio communication terminals.

(8) The processing device according to (7), wherein
the processing unit is configured to cause the size of the untransmitted data included in the first data to be transmitted from any of the radio communication terminals with a relatively high first priority to be larger than the size of the untransmitted data included in the first data to be transmitted from any of the radio communication terminals with a relatively low priority.

(9) The processing device according to (7), wherein
the processing device is configured to receive identification information of a data generation source and a priority of the generation source from an external device.

(10) A base station comprising:
the processing device according to one of (1) to (9);
a radio device configured to communicate with the processing unit; and
a communication device configured to communicate with a network.

(11) A communication system comprising:
a base station; and
a server connected to a network, wherein the base station comprises:
   the processing device to one of (1) to (9);
   a radio device configured to communicate with a terminal; and
   a communication device configured to communicate with the network.

(12) A communication method for a base station including a first layer and a second layer, the communication method comprising:
receiving first data from the first layer;
generating second data by changing the first data; and
transmitting the second data to the second layer, wherein
the first data includes a communication resource allocation request indicating a size of untransmitted data among data to be transmitted to the base station; and
the processing unit is configured to generate the second data by changing the size of the untransmitted data.

(13) A non-transitory computer-readable storage medium storing computer-executable instructions that, when executed, cause a computer to
receive first data from a first layer in a base station, the base station including the first layer and a second layer, the communication method comprising:
generate second data by changing the first data; and
transmit the second data to the second layer, wherein
the first data includes a communication resource allocation request indicating a size of untransmitted data among data to be transmitted to the base station; and
the processing unit is configured to generate the second data by changing the size of the untransmitted data.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing device for a base station including a first layer and a second layer, the processing device comprising:
a receiver unit configured to receive first data from the first layer;
a processing unit configured to generate second data by changing the first data; and
a transmitter unit configured to transmit the second data to the second layer, wherein
the first data includes a communication resource allocation request indicating a size of untransmitted data among data to be transmitted to the base station; and
the processing unit is configured to generate the second data by changing the size of the untransmitted data.

2. The processing device of claim 1, wherein the processing unit is configured to
estimate transmission timing of the data to be transmitted to the base station; and
generate the second data before the transmission timing.

3. The processing device of claim 2, wherein the processing unit is configured to
estimate a transmission size of the data to be transmitted to the base station; and
change the size of the untransmitted data depending on the transmission size.

4. The processing device of claim 3, wherein the processing device is configured to receive identification information of a data generation source, a data generation cycle, and a data size from an external device; and
generate the second data based on the identification information, the data generation cycle, and the data size.

5. The processing device of claim 3, wherein the processing unit is configured to
cause the receiver unit to receive first allocation information indicating a communication resource determined, in response to the second data, by the second layer; and
update the size of the untransmitted data depending on the transmission size and the first allocation information.

6. The processing device of claim 1, wherein the processing unit is configured to
generate third data including a second allocation request from the first data;
cause the transmitter unit to transmit the third data to the second layer;
cause the receiver unit to receive second allocation information indicating a communication resource determined, in response to the second allocation request, by the second layer; and
cause the transmitter unit to transmit the second allocation information to the first layer.

7. The processing device of claim 1, wherein
the first layer is connected to radio communication terminals;
the first data is data to be transmitted to the first layer by each of the radio communication terminals;
a priority is determined for each of the radio communication terminals; and
the processing unit is configured to generate a plurality of the second data by changing the plurality of a plurality of the first data to be transmitted from the radio communication terminals based on the priorities of the radio communication terminals.

8. The processing device of claim 7, wherein
the processing unit is configured to cause the size of the untransmitted data included in the first data to be transmitted from any of the radio communication terminals with a relatively high first priority to be larger than the size of the untransmitted data included in the first data to be transmitted from any of the radio communication terminals with a relatively low priority.

9. The processing device of claim 7, wherein
the processing device is configured to receive identification information of a data generation source and a priority of the generation source from an external device.

10. A base station comprising:
the processing device of claim 1;
a radio device configured to communicate with the processing unit; and
a communication device configured to communicate with a network.

11. A communication system comprising:
a base station; and
a server connected to a network, wherein the base station comprises:
the processing device of claim 1;
a radio device configured to communicate with a terminal; and
a communication device configured to communicate with the network.

12. A communication method for a base station including a first layer and a second layer, the communication method comprising:
receiving first data from the first layer;
generating second data by changing the first data; and
transmitting the second data to the second layer, wherein
the first data includes a communication resource allocation request indicating a size of untransmitted data among data to be transmitted to the base station; and
the processing unit is configured to generate the second data by changing the size of the untransmitted data.

13. A non-transitory computer-readable storage medium storing computer-executable instructions that, when executed, cause a computer to
receive first data from a first layer in a base station, the base station including the first layer and a second layer, the communication method comprising:
generate second data by changing the first data; and
transmit the second data to the second layer, wherein
the first data includes a communication resource allocation request indicating a size of untransmitted data among data to be transmitted to the base station; and
the processing unit is configured to generate the second data by changing the size of the untransmitted data.
